(19) United States
(12) Patent Application Publication
(10) Pub. No.: US 2026/0275231 A1
(43) Pub. Date: Sep. 17, 2026

(54) REUSABLE CANDLE LINER, CANDLE PRODUCT, AND CANDLE HOLDER

(71) Applicant: Homeport Candles Limited, Ballymena (GB)

(72) Inventor: Hanri Lourens, Ballymena (GB)

(21) Appl. No.: 19/562,212

(22) Filed: Mar. 10, 2026

(30) Foreign Application Priority Data
Mar. 11, 2025 (GB) 2503524.7

(51) Int. Cl. C11C 5/00; F21V 35/00

(52) U.S. Cl. CPC C11C 5/008; C11C 5/006; F21V 35/00

(57) ABSTRACT

A reusable candle liner 100 comprising an integrally moulded shaped form comprising a base portion 10, on which the reusable candle liner 100 is configured to stand, and a side wall 30 enclosing a interior cavity 40, suitable for placement of a candle, wherein said shaped form of the reusable candle liner 100 further comprises a flexible material, configured to release the candle, or wax 60 residue, by slippage, under elastic or mechanical deformation of the flexible material, before substantially resuming an original shape of the shaped form when said deformation is released. A candle product 200 comprising a reusable candle liner 100 and further comprising wax 60 and at least one wick 70. A candle holder 300 comprising a reusable candle liner 100 or a candle product 200.

### FIELD OF THE INVENTION

The embodiments of the present invention relate to a reusable candle liner. Said liner is suitable for use in a candle holder and is configured to contain wax, or other material, which is designed to burn as a candle.

### BACKGROUND OF THE INVENTION

Candles and candle holders are increasingly popular as market products. Conventionally, a candle holder is a rigid container made of, e.g., glass or ceramic or metal material, into which a wax or other burnable material is placed, with a wick designed to control the burn effect. Glass jars with glass lids, containing poured wax as filling, are frequently available, as are similarly filled metal tins. Precast candles are intended to sit into preformed holders, some allowing the precast candle to significantly protrude above the holder and some requiring a drop of wax to be melted to affix the candle base to the holder. Candles are intended for release of perfumed scent, decorative or ambiance enhancement, or in the case of, e.g., a conventional tea light, gentle and controlled heating. Other options on the market comprise meltable scented (often wax) products, not designed to burn controlled by a wick, but designed to be heated indirectly, the liquifying block of material spreading with received heat in a containment holder and releasing a scent. Said material is designed to re-solidify on cooling and must be removed from the holder and discarded after use.

Any, or all, of these conventional products are subject to issues concerning residual wax after use. A candle holder retains at least some of the wax, especially close to the base of the holder, after the candle has reached the end of its useful life. In the case of a tea light candle, in which, perhaps, a more efficient use of available wax is achieved, residue remains. The tea light must be discarded after single use, thereby generating considerable waste and adding to landfill disposal. A candle holder must be cleaned after each candle is finished.

Where fragrance oils are used as part of the wax composition, these materials may be released into the environment as a side effect of conventional wax removal, where they may pose a threat to the environment as waste, as they may transfer to water, in a way harmful to any aquatic life.

Conventional methods to remove residual wax are time-consuming and tedious. Some are potentially risky and could cause injury (such as burns or cuts) to a person carrying out the cleaning. Traditional methods to remove, e.g., candle wax, include:
a freezing method, where frozen wax is hardened and shrunk for removal by an implement, such as a knife;
a boiling water method, where boiling water is poured into the holder, leaving space at the top, such that the wax is melted with the heat of the water and floats to the top, cooling the water hardening the wax at the surface for removal;
a double boiler method where a bath of hot water is used to heat the container, indirectly heating the wax, which is caused to melt, for pouring out of the container;
a warm bath method, where a bath of hot water is used to heat the container, the wax being softened through indirect heat and rendered susceptible to being prised out of the container;
an oven method, where a temperature of, e.g., 95^{o}C (degrees Celsius) in a preheated oven melts residual wax, allowing the wax to drip out of the holder - e.g. when the holder is heated in the oven, for 10 to 15 minutes, upside down on a baking sheet lined with aluminium foil to collect the dripping wax; and,
a hair dryer method, where the heat of the air from the hair dryer is used to soften the wax, allowing the wax to be wiped out of the holder with a paper towel.

Often, a necessary final step for these methods, and for other conventional wax removal methods, is cleaning with a cloth, or paper towel, or washing of the holder with detergent. This generates waste. Even when care is taken in the implementation of a cleaning process, there is often a thin layer of greasy material left in the holder. The washing process also spreads traces of residual wax over paper for disposal in landfill and into water used for cleaning, which is then drained away into wastewater systems.

Other problems of implementing these wax removal methods include:

damage to a candle holder or other surface through heat damage or scratching;

labour intensive methods with multiple steps; and,

messiness of the process, possibly including exposure of a person(s), flora and/or fauna (especially aquatic life) to potentially harmful materials, e.g. fragrance oils.

Some candle holders are intentionally designed for a single use purpose and cannot be effectively cleaned, being discarded after single use. This adds to waste and creates a negative effect on the environment, from both the perspective of volume of discarded material and the perspective of the type of material being thrown away. Some candle holders, which are theoretically reusable, are not reused because of the aesthetic and practical impact of traces of residual material not removed by cleaning. Also, frequently, these holders can only be used with a specific size of candle, tailored to the holder dimensions. The practicalities of residual wax removal are very restrictive and cumbersome.

Overall, removal of residual wax from a holder, e.g. a candle holder, is a time-consuming process, with potentially dangerous aspects for the person implementing the cleaning, possibly including exposure to hazardous chemicals.

In addition, ineffectiveness of the conventional cleaning methods leads to inadequate cleaning, resulting in use of single-use products or premature discarding of products designed for multiple use, as well as the early purchase of replacement products. These aspects contribute to the generation of excessive waste, usually sent to landfill, and trigger unnecessary consumption of more raw materials, energy, and processing, for the creation of replacement products, which in turn leads to the generation of yet more waste.

Solutions of the art to avoid the difficulties of conventional cleaning, point to provision of a dedicated and specific material layer, shaped to a holder (or firmly attached to it), to allow the wax to remove more easily. However, placing a layer of material inside the holder adds to the complexity of the production of the holder, as well as the cost, and is restricted by compatibility and conformability of the relevant materials. Said layer does not achieve the complete removal of residual wax, nor does it necessarily protect the user from handling chemicals or detergents in order to obtain a fully clean holder/layer.

### SUMMARY OF THE INVENTION

The embodiments of the present invention seek to overcome the difficulties of the art and provide a product for which wax removal is simplified and optimised and safe. In addition, a further goal of the embodiments of the present invention is to address reusability of candle and candle (holder) products, by easy wax removal and by facilitating multiple use of such products, through provision of product features to broaden the range of use, and to encourage ongoing use, multiple times, by ease of preparation for the next use, e.g. easy or optimised cleaning. In addition, the embodiments of the present invention seek to provide an environmentally friendly option, through reusability and reduction of waste and reduction of use of chemicals, reusability resulting in less consumption of products and consequent reduction in processing or manufacture or raw materials used, of/for replacement product.

The embodiments of the present invention achieve these objectives by :-

According to a first aspect of the present invention there is provided a reusable candle liner, comprising an integrally moulded shaped form comprising a base portion, on which the reusable candle liner is configured to stand, and a side wall enclosing a interior cavity, suitable for placement of a candle, wherein said shaped form of the reusable candle liner further comprises a flexible material, configured to release the candle, or wax residue, by slippage, under elastic or mechanical deformation of the flexible material, before substantially resuming an original shape of the shaped form when said deformation is released.

Advantageously, this flexible material allows for easy and efficient wax removal, especially removal of (small amounts of) residual wax after candle burning. Flexing of the material promotes wax to slip along the shaped form and away from the deformed base and/or side wall of the liner, for expulsion. Choice of a flexible material allows the reusable candle liner to efficiently and safely accommodate cleaning of the liner, while also allowing the liner to return to an original shape for subsequent use(s). This promotes reuse of the liner, avoiding purchase of replacement product and thereby preventing waste and, also, reducing use of materials and energy which would be required for the manufacture of replacement or single-use products. Thereby, providing an environmentally friendly alternative to single-use candle products.

Optionally, the flexible material comprises a flexibility characteristic of Rebound percentage (%), which is configured to be within a range of 30% to 50%, more preferably in a range between 45% to 50%, and even more preferably in a range between 48% to 50%. (All quoted ranges are inclusive).

Advantageously, the flexibility of the material, of the shaped form of the reusable candle liner, can be expressed by reference to Rebound percentage (%) and is, preferably, configured to fall within specific range(s). The ranges of 30% to 50% inclusive, 45% to 50% inclusive, and 48% to 50% inclusive, have been established as optimal, for allowing sufficient deformation of the flexible material, to achieve technical effect in removal of wax (or candles), without compromise of other characteristics of the reusable candle liner, such as a sufficiently strong and stable (wall) structure, for safe and purposeful use.

Optionally, the side wall is configured as extending from the base portion, continuously, in an upward direction away from the base portion, the flexible material being configured with sufficient hardness to be self-supporting and maintain linear structure of the side wall.

Advantageously, this flexibility in conjunction with sufficient hardness of the material facilitates a free-standing liner which does not require additional support from, e.g., a wall of a holder. Thus, the reusable candle liner can be used in a variety of ways and circumstances, and used in many different candle holders, specific sizing not being required.

Optionally, the side wall comprises a wall thickness which is greater proximate to the base portion at a bottom tapered portion of side wall and is tapered to be thinner at a top tapered portion of the side wall remote from the base portion and proximate to the top.

Advantageously, this allows for greater mechanical strength and less transfer of heat near the base, as well as better stability for free-standing of the liner. Less material at the top facilitates the top part of the wall to distance from any candle flame, as well as being more aesthetically pleasing.

Optionally, an edge of the base portion extending into the side wall is configured as a curved corner.

Advantageously, such a curved corner facilitates easier moulding of the reusable candle liner and, further, provides a less tight fit at a base of a candle holder (into which the liner can be inserted), especially if the liner is a similar size to said holder, for optimised placement into, or removal from, the candle holder. Also, the ambient air around the base of the liner is increased, while not adversely affecting the stability of the liner in a free-stand position. Further advantageously, the curved corner further facilitates easy wax removal.

Optionally, the flexible material of the shaped form comprises a silicone material, preferably high-grade silicone.

Advantageously, silicone material provides limited or reduced heat transfer through the material from a candle in use, as well as being suitable for a normal candle burning temperature with good safety margin. Silicone is easy to mould, and is flexible, reusable over a relatively long lifetime, and provides sufficient slippage for easy wax removal. The material is Eco-friendly. In addition, the flexible silicone material of the reusable candle liner comprises high-grade silicone, i.e. said material comprises very limited traces of other compounds, and, particularly, no European Union regulated or restricted compounds, the silicone material being certified under REACH and ROHS. Said material is safe to use at high temperatures (e.g. up to 200⁰C) and is chemically safe when in contact with other materials. Silicone is a non-toxic material, which does not break down into environmentally harmful microplastics, and is recyclable, thereby reducing environmental impact.

Optionally, said silicone material comprises a Shore Hardness, SH, in a range between 30A and 70A, inclusive.

Advantageously, Shore Hardness (SH) is used as a measure of resistance to indentation and provides indication of sufficient hardness of the material to allow self-supporting, free-standing of the liner. The present inventor has also associated preferred SH values between 30A and 70A, inclusive, of the silicone material with preferred Rebound percentage (%), which allows for sufficient flexibility of the reusable candle liner to achieve the desired technical effect of easy wax removal and return to original shape for subsequent use.

Optionally, the Shore Hardness, SH, of the silicone material is 60A or 40A.

Advantageously, the present inventor has established these preferred Shore Hardness (SH) values, as optimal for a reusable candle liner material according to the embodiments of the present invention, to ensure structural stability and retention of substantially original form, especially after any deformation of the material for wax removal.

Optionally, a height of the side wall is related to the Shore Hardness, SH, of the silicone material chosen, such that the SH is harder for a liner with a higher or taller side wall than a liner with a lower or shorter side wall.

Advantageously, this allows for variation in height of the side wall of the reusable candle liner, without ‘hang over’ of the side wall towards any flame. Too weak a material, too tall to be properly self-supporting, results in a side wall which does not optimally facilitate candle burning. Preferably, the reusable candle liner is self-supporting throughout the entire side wall height.

Optionally, the silicone material is configured to comprise a heat tolerance in a range between 0⁰C and 200⁰C, inclusive, and to accommodate a wax surface temperature in a range between 0⁰C and 160⁰C, inclusive, and preferably at around 80⁰C, i.e. 80 degrees Celsius.

Advantageously, heat transfer is reduced over a wide range of temperatures, even above a normal operating temperature, thereby providing extra thermal protection external to the reusable candle liner when in use.

Optionally, the side wall is shaped, around a circumference of the reusable candle liner, to comprise a free-form or a geometric shape, said geometric shape preferably comprising at least one of the following shapes : an oval, a circle, a decagon, a pentagon, an extended hexagon, a triangle, a rectangle, a square with curved corners, a square with cut-out corners.

Advantageously, a very wide range of possibilities for shaping the liner exist, while facilitating the advantage of a free-standing liner and further advantage of easy (residual) wax removal advantage. The reusable candle liner is suitable for a wide range of other candle (holder) products and can be tailored to any desired shape and form to be accommodated, if a matched form is required. Curved or cut-out corners allow a channel of air to be present through the height of the liner, for easier removal if the liner is intended to be in contact with a holder.

Optionally, the side wall is shaped as symmetric around a central axis (CC) of the reusable candle liner.

Advantageously, a section line CC may be a central axis of the liner, about which it is (rotationally) symmetric. However, this axis is not limited, in application, to a circular form of the side wall of the reusable candle liner. This symmetry facilitates easier and less expensive manufacturing of said liner. In addition, in use, a more even candle burn is achieved, as the quantities of wax between a side wall and a wick are symmetrical, resulting in more even heat transfer and wax melt.

Optionally, a refill line is provided on the side wall, adjacent to the interior cavity, comprising a ring around a circumference of the side wall, substantially parallel to the base portion, at a height above the base portion corresponding to a minimum depth of candle material or wax in the reusable candle liner.

Advantageously, provision of a refill line facilitates safe use of the candle, indicating a remaining height of wax below which the candle should not be used/burned, for safety. Additionally, the refill line functions as a reminder to the user to refill the liner with wax. Preferably, the refill line forms a continuous ring around the interior cavity, for ease of indication and, also, for long term availability of the marking in case of any limited damage. However, it is also possible to provide a short line on only a portion of the circumference of the liner. Advantageously, the refill line position may correspond to guidance concerning safe use or burning of wax or candle (material).

Optionally, the refill line is configured as an indent or a protrusion or a marking, on an interior surface or an exterior surface of the side wall.

Advantageously, such implementation makes the refill line an inherent part of the liner construction, thereby being available as a safety indication for the lifetime of the reusable candle liner.

Optionally, the height of the refill line above the base portion is configured as between 10mm and 13mm, preferably as 11mm or 12mm.

Advantageously, this marker for minimum safe level of wax remaining (during burning, i.e. in use) corresponds to (at least) United Kingdom safety standards guidelines.

Optionally, the reusable candle liner is configured as comprising :-
a width, across a diameter, at or proximate to the top : 79.4mm;
a width, across the diameter, at or proximate to the bottom : 73mm;
an internal liner height : 73mm;
a refill line height from the base : 11mm;
a refill line height from the top : 61mm;
an outside (external) corner curve radius of curvature : 9.92;
an inside (internal) corner curve radius of curvature : 8.8; and
a maximum recommended volumetric or weight capacity for wax : 220g; and,
wherein, the flexible material is configured to comprise a Shore Hardness of 60A and a Rebound percentage (%) of 48%.

Optionally, the reusable candle liner is configured as comprising :-
a width, across a diameter, at or proximate to the top : 80mm;
a width, across the diameter, at or proximate to the bottom : 73.5mm;
an internal liner height : 45mm;
a refill line height from the base : 11mm;
a refill line height from the top : 33mm; and a
maximum recommended volumetric or weight capacity for wax : 150g; and,
wherein, the flexible material is configured to comprise a Shore Hardness of 40A and a Rebound percentage (%) of 50%.

Advantageously, a reusable candle liner comprising (either of) these specific sets of characteristics form basis for particularly effective implementations of the embodiments of the present invention. As supported by experimentation, by the present inventor.

According to a second aspect of the present invention there is provided a candle product comprising a reusable candle liner, and further comprising wax and at least one wick.

Advantageously, the reusable candle liner achieves a technical effect of free-standing support of the candle wax material, and wick, even without an additional candle holder, and need not be dedicated to sizing relative to said candle. In addition, such a liner can be specifically conformed to present standard (pre-formed) candles, for use with any market brand. Thus, the liner, filled with wax and provided with a wick, forms a candle product which can be used independently. And refilled after easy removal of residual wax.

Optionally, the wax comprises at least one of : wax beads; solid wax block; molten wax, cooled.

Advantageously, the free-standing form of the reusable candle liner facilitates independent structure, thereby being sufficiently strong (without wax filling assisting in the support of the side wall) to allow many types of wax to be used as burnable product.

Optionally, the wax material comprises: soy, or coconut, or rapeseed, or paraffin, or beeswax, or palm wax, or gel wax, or any blended combination thereof.

Advantageously, as waxes and wax blends comprise their own characteristic burning temperature(s), the reusable candle liner is configured for safe burning at normal and higher burning temperatures and can, consequently, accommodate a wide range of burnable wax materials.

Optionally, the at least one wick is provided with a stabilization disc.

Advantageously, this facilitates better stabilization of the wick and improves the safety of the candle product during burning.

According to a third aspect of the present invention there is provided a candle holder comprising a reusable candle liner or a candle product.

Advantageously, no sizing relationship (except that the holder is not intended to be smaller than the liner, e.g. in diameter) is required between candle holder and liner because of the free-standing (nature) of the liner, although it is equally possible to effect a specific relative sizing, due to the ease of forming the liner to a desired shape. Also, the candle holder can be provided with an empty liner, as part of candle holder product, as the liner can be filled by a user with a preferred wax.

Optionally, further comprising a consistent gap between an inner surface of the wall of the candle holder and an outer surface of the side wall of the reusable candle liner.

Advantageously, the consistent gap improves safety during candle burning by ventilation and by air insulation between liner and holder, as well as heat transfer resistance towards the candle holder. The gap is effected by the free-standing wall of liner, which allows such a gap to be maintained.

Optionally, a width of the gap is configured between 0mm and 5mm.

Advantageously, a wide range of gaps can be defined, as desired, for mutually designed holders and liners with specific slippage properties because of liner material; for different heights of a liner relative to a candle or a candle holder; for different materials of candle holder, some of which may be more heat sensitive than others; for free forms of liner which can accommodate irregular or varying candle holder shape but yet remain independent of any holder wall support.

Optionally, the width of the gap is around 2mm, i.e. 2 millimetres.

Advantageously, the present inventor has established this size of gap as optimal for a trade-off between accommodation of reduced heat transfer characteristics and aesthetics of the candle holder. As well as ease of insertion of the reusable candle liner into the candle holder.

The features of the invention are susceptible to being combined in any combination without departing from the scope of the invention as defined by the appended claims.

### BRIEF DESCRIPTION OF THE DRAWINGS

The various embodiments of the present invention will now be described in more detail by reference to the figures. These examples are for illustrative purposes and should not be considered as limiting. Where reference numerals indicate a specific feature which is consistent across the figures, the associated reference numeral is kept similarly consistent.

FIG. 1, parts A to D, shows a schematic illustration of a reusable candle liner according to the embodiments of the present invention. FIG. 1A shows a cross-section of the reusable candle liner from a side view, and further indicates two section lines AA and BB. FIG. 1B shows a cross-section of the reusable candle liner through a wall portion, along section line AA, while FIG. 1C shows a cross-section of the reusable candle liner through a base portion, along section line BB. FIG. 1D shows a cross-section of a filled reusable candle liner (of FIG. 1A), forming a candle product of the embodiments of the present invention.

FIG. 2 shows schematic illustration of wall shapes of the reusable candle liner according to the embodiments of the present invention, as viewed from above (top view).

FIG. 3, parts A to E, shows schematic illustration of a first example of the reusable candle liner according to the embodiments of the present invention. FIG. 3A shows a perspective view of said first example. FIG. 3B shows a side view of said example, and further indicates section line CC. FIG. 3C shows a cross-section of said first example, along section line CC. FIG. 3D and FIG. 3E show cross-sections of second and third examples, respectively, of the reusable candle liner of the embodiments of the present invention.

FIG. 4, parts A and B, shows schematic illustration of examples of a candle product according to the embodiments of the present invention, as viewed from above (top view).

FIG. 5, parts A to C, shows schematic illustration of examples of candle holders according to the embodiments of the present invention, as viewed from above (top view).

FIG. 6, parts A and B, shows further schematic illustration of the candle holder of FIG. 5A. FIG. 6A shows a top view of said candle holder and FIG. 6B the associated cross-section across a diameter, both FIG. 6A and FIG. 6B illustrating a gap between the reusable candle liner exterior wall and the interior wall of the candle holder body.

### DETAILED DESCRIPTION OF THE DRAWINGS

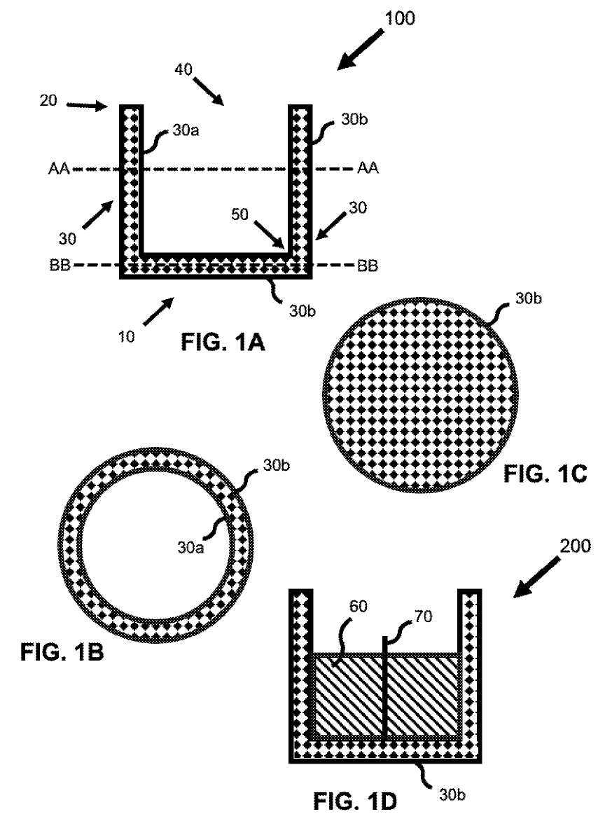

FIG. 1, parts A to D, shows a schematic illustration of a reusable candle liner 100 (also referred to as ‘the liner’ 100) according to the embodiments of the present invention. FIG. 1A shows a cross-section of the reusable candle liner 100 from a side view, and further indicates two section lines AA and BB. FIG. 1B shows a cross-section of the reusable candle liner 100 through a wall portion, along section line AA, while FIG. 1C shows a cross-section of the reusable candle liner 100 through a base portion, along section line BB. FIG. 1D shows a cross-section of a filled reusable candle liner 100 (of FIG. 1A), forming a candle product 200 of the embodiments of the present invention.

FIG. 1A shows a cross-section of a reusable candle liner 100, according to the embodiments of the present invention, comprising a base portion 10 (also referred to as the base 10), on which the liner can sit stably, in balance. Integral to the base portion 10 and extending away from it in an upwards direction towards a top 20, is a side wall 30 (also referred to as the wall 30). For the purposes of explanation, this side wall 30 is shown here as circular surrounding a circular base 10, but this should not be considered as limiting. The side wall 30, together with the base portion 10, defines an interior cavity 40 of the reusable candle liner 100. The material forming the base portion 10 and the side wall 30 comprises an interior surface 30a and an exterior surface 30b. A corner 50 is indicated where the base portion 10 and side wall 30 are deemed to meet, the preferred integral nature of the forming of the material shaping the liner 100 not producing a specific material join. It should be noted that this integral construction is advantageous for fabrication and production of the liner but is not essential. The reusable candle liner 100 could be made from two pieces with a base part joined to a side wall part, if desired. The corner 50 is shown in FIG. 1A as comprising a sharp turning of approximately 90⁰ (degrees). This is an example only, both in angle and degree of sharpness. Later figures will show a different, curved, shape of this corner region, which has advantage for the easy removal of wax. Also shown in later figures, the side walls 30 can be formed such that the liner 100 is wider at the top 20 than the bottom 10, i.e. the walls 30 are sloped. The thickness of the material between interior surface 30a and exterior surface 30b of the wall 30 allows the reusable candle liner 100 to be free-standing, while maintaining flexibility of the material to facilitate easy wax 60 removal.

A preferred material for construction of the reusable candle liner 100, according to the embodiments of the present invention, is silicone. Silicone is :- flexible, advantageously the material promotes ease of removal or change of wax 60n sustainable manner; has a high temperature threshold, advantageously the material is flame resistant; and non-toxic, advantageously the material is environmentally friendly.

In order to achieve a material characteristic of flexibility, other possible materials suitable for the liner 100 tend to be limited to plastic polymers. Most plastic polymers do not present well, in consideration of reusability and toxicity, for example.

Further advantage of silicone material comprises: stability and non-reactivity towards other chemicals and/or materials; non-toxic composition; recyclability; does not disintegrate to produce micro-plastic(s); naturally flame resistant; not thermally conductive; durable, due to the robust polymer chain comprised in the material structure. In addition, the material of the reusable candle liner is designed to comprise high-grade silicone, with very limited traces of other compounds, and particularly no European Union regulated or restricted compounds, the silicone material being certified under REACH and ROHS. Said material is safe to use at high temperatures (e.g. up to 200⁰C) and is chemically safe when in contact with other materials. Silicone is a non-toxic material, which does not break down into environmentally harmful microplastics, and is recyclable, thereby reducing environmental impact.

Resistance to indentation of a material can be expressed by means of a known parameter of Shore Hardness (SH). Conventionally, Shore Hardness is (usually) a measure of the resistance a material has to indentation. The Shore durometer is a device for measuring the hardness of a material, typically of polymers. The Shore hardness scale is an internationally accepted standard that quantifies the hardness of a material. Higher numbers on the scale indicate a greater resistance to indentation and thus harder materials. Lower numbers indicate less resistance and softer materials. There are (three) different Shore Hardness scales for measuring the hardness of different materials (soft rubbers, rigid plastics, and supersoft gels, for example). Each of the three scales operates within a numeric range of 00 to 100, with 00 being the softest material and 100 being the hardest. Shore 00 concerns soft and flexible materials such as gels, soft foams, and highly flexible rubbers. Shore A concerns flexible mould rubber materials, including most rubbers from extremely soft and flexible up to hard rubbers with minimal flexibility, and also non-rubber plastics that are semi-rigid and somewhat flexible. Shore D concerns hard and semi-rigid plastics and rubbers.

As recognised by the present inventor, this parameter is also an indirect measure of the flexibility of a material, especially as relevant to the embodiments of the present invention, as a leading indicator of suitability for implementation. Flexibility, as discussed herein, being defined as the ability of a material to deform under stress without permanent damage or permanent shape change. Rebound percentage (%) is another associated consideration, this parameter frequently being related to Shore Hardness, but not always varying greatly in value over a Shore Hardness range, depending on the material. Rebound percentage (%) can be considered as a measure or indicator of how well a material can return to its original form and may be reflective of a material’s elasticity (elasticity being defined, herein, as a material shape change when a force is applied and an ability to return to a substantially original shape when a force is removed, the internal structure of the material also substantially returning to its original form).

By experimentation, the present inventor has established that a preferred silicone material for producing a reusable candle liner 100, according to the embodiments of the present invention, comprises a Shore Hardness of 60A, use of silicone of Shore Hardness 40A also being particularly suitable for said embodiments. A preferred range of Shore Hardness of the silicone material is between 30A and 70A, inclusive. For silicone material of SH between 10A and 95A, an associated Rebound percentage (%) of exemplary material is between 35% to 50%, inclusive, 35% percent being associated with a higher 90A Shore Hardness material and other Shore Hardness values being associated with a Rebound percentage (%) of between 45% and 50%, inclusive. For preferred material of SH 40A and SH 60A, the Shore Hardness of exemplary material, associated Rebound percentages (%) have been indicated at 50% and 48%, respectively. Thus, a preferred associated Rebound percentage (%), of silicone material for implementation of the embodiments of the present invention, lies in a preferred range between 48% and 50%, inclusive.

A precise choice of Shore Hardness for a silicone material is considered in light of a specific design of the liner 100, so as to maintain the free-standing characteristic of the liner 100, with stability of side wall 30, in use, while also maintaining advantageous flexibility for removal of residual wax 60. Particularly important, is a situation where candle wax 60 is diminished in volume and retreats as melted wax 60 towards the base 10 area of the interior cavity 40, leaving the side wall 30 self-supporting. In general, for a consistent diameter, a liner 100 with a relatively tall side wall 30, would require a material of higher (i.e. larger) Shore Hardness (SH) than a similar liner 100 with a less tall side wall 30. For example, for a circular wall liner 100, comprising a circular wall 30, according to the embodiments of the present invention, comprising diameter around 79.4mm (millimetres) and internal height of around 73mm, a silicone material with Shore Hardness (SH) of 70A would facilitate a tapered wall 30 thickness (thinner at the top than at the bottom) of 1mm and 2mm, respectively. Similarly, SH 60A facilitates thicknesses of 1.5mm (top) and 3mm (bottom), 40A 1.5mm and 3mm, and 30A 2mm and 4mm, respectively. These examples should not be considered as limiting.

Also, larger (or greater) Shore Hardness can facilitate a change in liner 100 diameter towards a larger diameter of the liner 100. By way of example, which should not be considered a limiting, details of exemplary (approximate) sizes of (relatively) small, medium and large liners 100 , comprise -
Small: Upper wall thickness of 1mm; Bottom wall thickness of 2mm; Internal Diameter of 60mm; Internal Height of 50mm and Shore Hardness of the material of between 30A to 40A
Medium: Upper wall thickness of 1.5mm; Bottom wall thickness of 3mm; Internal Diameter of 80mm; Internal Height of 70mm and Shore Hardness of the material of between 40A to 60A
Large: Upper wall thickness - 2mm; Bottom wall thickness - 4mm, Internal Diameter - 100mm; Internal Height - 100mm; Shore Hardness of the material of between 60A to 70A

Small:Upper wall thickness of 1mm; Bottom wall thickness of 2mm; Internal Diameter of 60mm; Internal Height of 50mm and Shore Hardness of the material of between 30A to 40A

Medium:Upper wall thickness of 1.5mm; Bottom wall thickness of 3mm; Internal Diameter of 80mm; Internal Height of 70mm and Shore Hardness of the material of between 40A to 60A

Large:Upper wall thickness - 2mm; Bottom wall thickness - 4mm, Internal Diameter - 100mm; Internal Height - 100mm; Shore Hardness of the material of between 60A to 70A

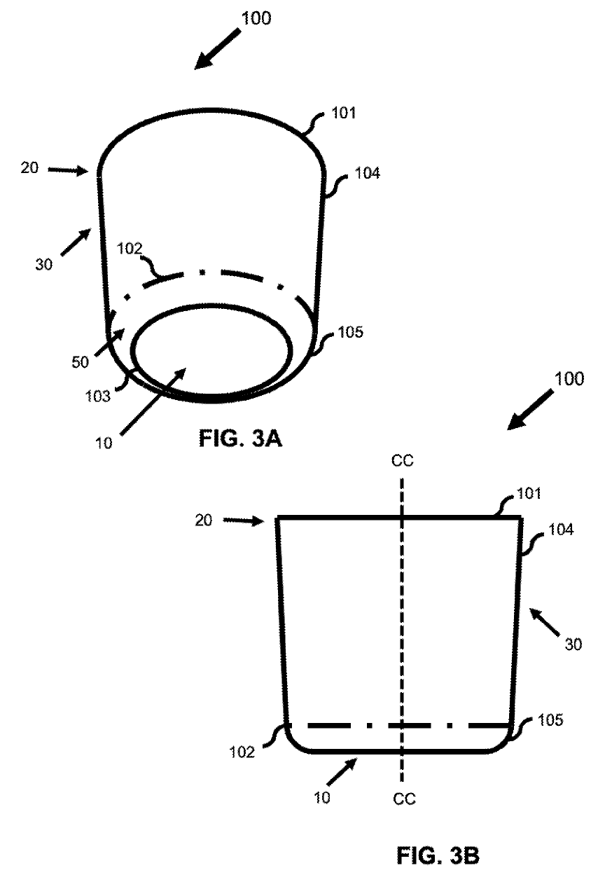

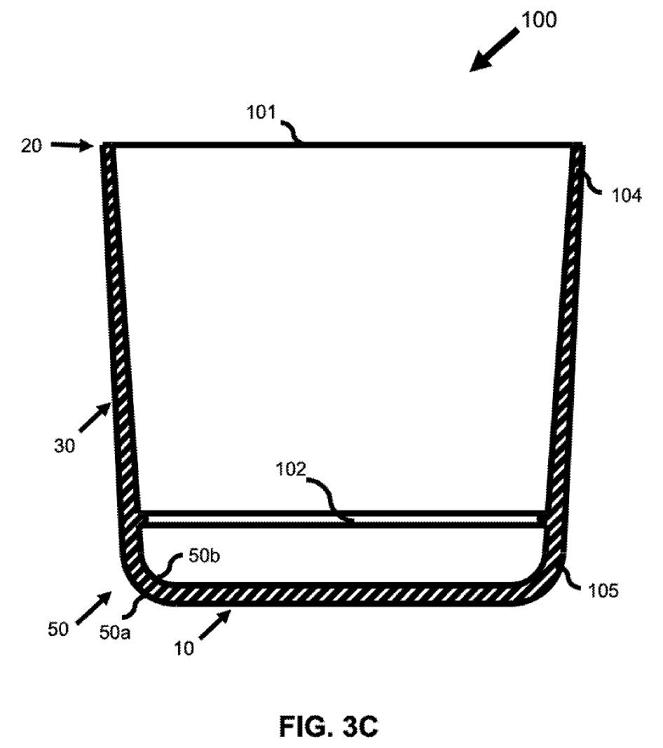

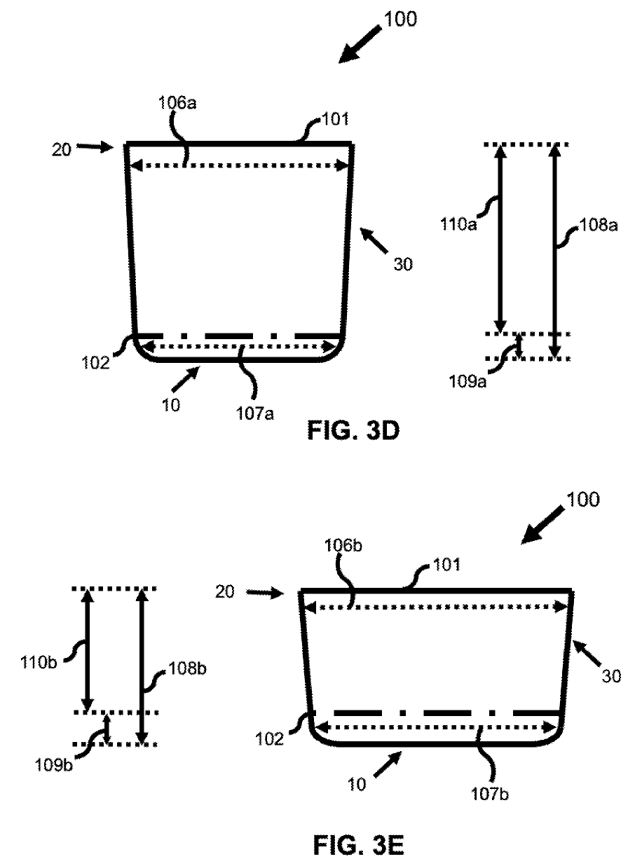

(For other specific configured examples, see later figures, FIGS. 3D and 3E, and associated text).

The silicone material is suitable for injection or compression moulding processes, which are preferred methods of manufacture of the reusable candle liner 100. Said liner 100 can be moulded as an integral piece, thereby avoiding any issues of joining between base portion 10 and side wall(s) 30. It is also preferred that the side wall 30 of the liner 100 is continuous, without a top-bottom (vertical) join, to maintain heat properties consistently around the side(s) of the liner 100.

Referring again to FIG. 1A, two section lines AA and BB are shown in FIG. 1A. These section lines are approximately parallel to the base portion 10 and, thus, these lines each run in a plane approximately horizontal to normal ground level. Section line AA crosses through the side wall 30, while section line BB crosses through the base portion 10. The resulting sections of the reusable candle liner 100 (of FIG. 1A) are shown in FIG. 1B and FIG. 1C, respectively.

The reusable candle liner 100 is intended for use with meltable wax 60, designed to burn as a candle, with the aid of at least one wick 70. FIG. 1D shows, schematically, the liner of FIG. 1A, with wax 60 and a single wick 70 introduced into the interior cavity 40, to form an example of a candle product 200, according to the embodiments of the present invention. The wick 70 may be provided with a stabilization disc (not shown). The wax 60 can be filled into the interior cavity 40 of the liner as close to the top 20 as required. In use, the wax 60 burns down, aided by the wick 70, the volume of wax 60 gradually reducing, melting and pooling further towards the base of the liner 100.

The reusable candle liner 100, according to the embodiments of the present invention, can be filled and re-filled with wax 60 of various types. Eco-friendly wax or candles can be used, such as wax or candles made from soy, beeswax, or other sustainable materials. The liner 100 can be refilled, which facilitates reuse. Liquid, solid or wax pieces, such as wax beads, can also be used. In addition, refill materials are often available in bulk packaging, thereby reducing overall consumption of packaging materials and reducing waste. Thereby, providing an environmentally friendly option.

When wax 60 is provided in the form of a candle wax block to an empty liner 100, it is advantageous to provide a candle wax block (e.g. with a wick 70) to said liner 100 which is configured to match in size. With a size, e.g. diameter, such that a gap to the liner wall 30 is established. A slippage gap of between 0mm and 3mm is suitable, with preference for a slippage gap of around 1mm. In addition to the nature of the chosen silicone material, which allows slippage, this slippage gap further facilitates easy insertion of the candle wax block into the liner 100. However, a preferred slippage gap, of around 1mm, is chosen in consideration of easy insertion and the later burning of the candle. After insertion, when the candle is in use and during burning, the melting of the wax 60 will redistribute the wax material in interior cavity 40 towards the side wall 30. A slippage gap of around 1mm facilitates even and swift wax 60 redistribution. E.g., FIG. 1D schematically shows such a candle having been burned in use and with wax 60 consequently redistributed.

Interpretation of traditional (or conventional) candle safety guidelines (e.g. the British Candle Makers Federation point to various guidelines, including BS EN 15493.2019 and EN ISO 13732-1-2000) preclude a conventional candle holder reaching temperatures exceeding 75⁰C (degrees Celsius). And experimentation points to a wax (blend) surface temperature not exceeding 80⁰C. Above these temperature indications, a user can burn themselves if they touch, or come into contact with, the holder. The materials of the reusable candle liner 100, according to the embodiments of the present invention, are chosen to consistently withstand at least temperatures up to 80⁰C, falling within the guidelines but with (preferred) extra performance up to 160⁰C. A (preferred) silicone material can withstand temperature consistently up to 180⁰C. Thus, if heat is consistently applied at 180⁰C, there is no negative impact on the material, e.g. no degradation or loss of structural integrity. The silicone can withstand ‘intermittent’ temperature up to 200⁰C. Safe candle guidelines of the art require a user to limit burning of a candle to less than four hours at a time. Four hours would usually be classified as ‘intermittent’. Thus, even if a candle were to grossly fail and heat was to be significantly high, the silicone of the reusable candle liner 100 would have a sufficiently large working temperature range, facilitating safety even in adverse burning conditions.

A conventional candle could produce additional heat due to improper candle care. For example, foreign material could land within the candle, ignite and become an additional wick, thereby creating more heat than required or intended. Such foreign material could include: a broken off part of a wick, due to the user not trimming the wick; organic material from a plant; or, discarded matches.

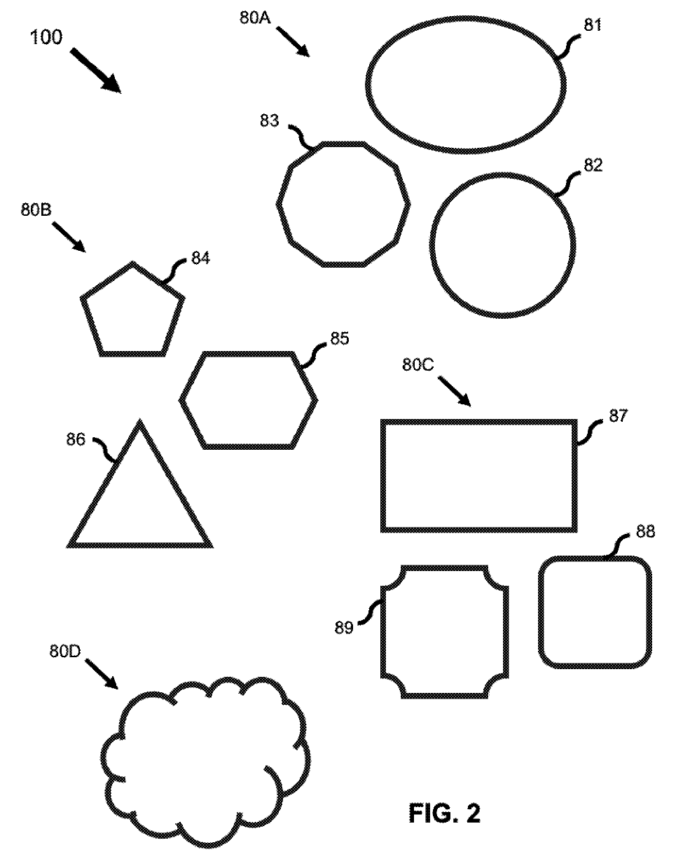

FIG. 2 shows schematic illustration of wall shapes 30 of the reusable candle liner 100 according to the embodiments of the present invention, as viewed from above (top view).

In the figure, examples are grouped into exemplary shape groups 80 A to D. The solid lines indicate the shape of the wall 30 at the top 20 (i.e. top view, looking downwards), but are not intended to indicate any particular thickness. For example, said solid lines can be considered as following a circumference (not limited to a circular form) of the top of the side wall 30. The wall 30 (substantially) maintains the shape towards the base 10. An advantage of the material of the reusable candle liner 100 is its flexibility, while maintaining form and strength to allow the liner 100 to stand independently. Not only does this flexibility allow easy wax removal, it also facilitates a wide choice of side wall 30 shape.

For example, shape group 80A shows examples of side wall 30 shape which are approximately circular - this includes an oval 81, a circle 82, but also any kind of shape which approximates a circle or an oval using straight sides, such as a decagon 83, is possible. An advantage of smoother walls 30 of these shapes is ease of fabrication and ease of placement of any wick 70, as the wick 70 is easy to locate at an equal distance from each wall portion.

For example, shape group 80B shows examples of wall 30 shape which are angular and comprise relatively sharp points between sections - this includes a pentagon 84, an extended hexagon 85 and a triangle 86. Such shaping is possible due to the formability of the material of the reusable candle liner 100, and offers shaping not usually available in candle products. Wick 70 may be placed centrally or a plurality of wicks 70 may be used, placed in relation to the points comprised in the wall 30.

For example, shape group 80C shows examples of side wall 30 shape which are approximately rectangular - this includes a rectangle 87, but also any kind of shape which approximates a square or rectangle using straight sides, such as a square (or rectangle, not shown) with curved corners 88 or a square (or rectangle, not shown) with cut-out corners 89. And additional advantage of the latter examples (88 and 89) is the air channel(s) at the corner(s), which allows release of any vacuum-type force between the liner 100 and any wall or closed surface against which the liner is pressed, e.g. in a candle holder 300, to be discussed later.

For example, shape group 80D comprises a single cloud shape of side wall 30, to schematically indicate that the wall 30 may be free-formed into whatever shape may be desired for the reusable candle liner 100.

The reusable candle liner 100 described above, either by itself or filled with wax 60 and at least one wick 70 to form a candle product 200, can be comprised in a candle holder 300 (not shown in previous figures but, for example, as shown below in FIG. 5, parts A to C), contained within a wall 90 of the candle holder 300.

FIG. 3, parts A to E, shows schematic illustration of a first, a second and a third example of the reusable candle liner 100 according to the embodiments of the present invention. FIG. 3A shows a perspective view of said first example. FIG. 3B shows a side view of said first example, and further indicates section line CC. FIG. 3C shows a cross-section of said first example, along section line CC. FIG. 3D and FIG. 3E show cross-sections of said second and third examples, respectively, of the reusable candle liner 100 of the embodiments of the present invention.

It should be noted that the first to third examples, now discussed, are preferred embodiments of the present invention, and illustrate specific advantages, which will now be further outlined. The embodiments of the present invention are not limited to these examples, and features of these different examples can exist alone or be combined with any other embodiment of the present invention. For ease and clarity of illustration, the reusable candle liner 100 is shown comprising circular side wall 30 form (when viewed from above). Also for ease and clarity of illustration, the liner 100 is not shown as filled.

All figures, FIG. 3A to FIG. 3E, show the base 10, the top 20, and the side wall 30, of the reusable candle liner 100, for reference. FIG. 3A to FIG. 3E additionally show a top rim 101, indicating an end portion of the side wall 30 at the top 20 of the liner 100 which comprises a finite (width) thickness. Similarly, said figures also indicate a position of a refill line 102, which will be discussed below. The refill line 102, of these first to third examples, is provided on or in an interior (30a) surface of the liner 100 but may also be indicated on or in an exterior (30b) surface of the side wall 30, if desired. Said refill line 102 may be physically etched in the material of the side wall 30, marked with a colour, or be provided as a protrusion from the side wall 30, on either an exterior (30b) or an interior (30a) surface. Preferably, the refill line 102 is located, on side wall 30, above an end of the shaping of corner 50. But this should not be considered as limiting. Cross-section figures, FIG. 3B to FIG. 3E, are further provided with (solid line) indications of the top rim 101 and (solid or dashed) indications of refill line 102, for reference.

FIG. 3A to FIG. 3C relate to the first example of the reusable candle liner 100 according to the embodiments of the present invention.

Referring to FIG. 3A, said liner 100 is seen to comprise a specific base 10 form. The illustrated base (portion) 10 comprises a flat section on which the liner 100 stands stably. A base rim 103 circles the edge of the base portion 10. Such a form maintains the stability of the liner 100, regardless if placed into another holder or left to stand alone. This increases the safety of the liner 100 in use. In terms of the average (circular) area (widthways) of the liner 100, the base portion 10 preferably comprises a range of approximately 91% to 100% of said area, inclusive, for preferred stability. (As a non-limiting specific example, the second example of the reusable candle liner, shown schematically in FIG. 3D, and discussed later, comprises a base portion percentage of 91.9%). A smooth curve shape at corner 50 of the liner 100 allows for ease of removal of the liner 100 from any holder (not shown) and is further advantageous for manufacture of the liner 100, especially in, e.g., an injection or compression moulding process, making a smooth transition from base 10 to side wall 30. In addition, the illustrated liner 100 comprises a tapered side wall, such that a top tapered portion 104 of side wall 30 extends in a width or radial direction of the liner 100 more than a bottom tapered portion 105 of side wall 30 located in proximity to the base 10. For example, considering wall thicknesses, the side wall 30 can be designed with a smaller upper wall thickness and (gradually) extend to a bottom wall thickness, which can be the greatest or largest wall thickness of the liner 100. The wall can be configured for a maximum thickness at a height of approximately 11mm (and optionally consistent with a position of refill line 102) from the bottom of the internal portion of the base 10 of the liner 100. Such a maximum thickness can be configured to extend through the remainder of the liner 100, especially the base portion 10, thereby ensuring structure and stability.

Referring to FIG. 3B, showing an exterior side view of the liner 100, a section line CC is provided. This section line CC may be an axis of (rotational) symmetry of the reusable candle liner 100.

Referring to FIG. 3C, shows a side cross-section of the liner 100, along section line CC, and with the schematic addition of top rim 101 and refill line 102, as would be visible on an interior surface of the liner 100, had it been cut in two pieces along the section line CC.

This figure clearly indicates a preferred profile of the side wall 30 thickness : extending downwards from top tapered portion 104 to bottom tapered portion 105 the thickness of the wall gradually increases. The bottom tapered portion 105 is preferably configured to comprise a wall thickness greater than that of the top tapered portion 104. Such a configuration is advantageous for stability of the liner 100, the thicker bottom tapered portion 105 providing mechanical and structural strength as well as confirming stability, but the thinner top tapered portion 104 allowing for stability of the side wall 30, while maintaining the top of the side wall 30 away from the flame effect of a burning wick 70, when in use. The thin side wall is also configured to comprise a width which prevents collapse of the side wall 30 inwards, as the wax 60 is consumed and the volume of wax 60 filling the interior cavity 40 of the liner 100 diminishes. The thinner section, top tapered portion 104, being kept thin for aesthetic reasons, creates an overall illusion of a thin liner, when, in fact, it is robust in width in the bottom section, at e.g. bottom tapered portion 105. An outward angle of the top-most section, in addition to the tapering, further distances the side of the wall 30 away from the burning wick 70. The outward angle is an angle measured away from the vertical (or, e.g., from section line CC as shown in FIG. 3B, which may be an axis of symmetry of the liner 100). The outward angle is preferably around 2^{o} (2 angular degrees), or preferably within a range of 2^{o} to 4^{o},inclusive. The side wall 30 thicknesses and tapering 104105 (and angle to the perpendicular) can be varied depending on the volume (and, thus, the weight) of wax 60 to be contained inside the liner 100. The side wall 30 may comprise a linear structure, i.e. the wall may be substantially straight along its height. A preferred corner 50 shape is curved. An outside curve 50a comprises a different curvature with respect to an inside curve 50b. This different curvature facilitates smooth transition from the base portion 10 to the (tapered) side wall 30 (also concerning material thickness), according to an angle required between base 10 and side wall 30.

According to the embodiments of the present invention, based on experimentation by the present inventor, and using a silicone material with a shore hardness of 60A, a preferred thickness of top tapered portion 104 is between 1mm to 2mm (millimetres), 1.5mm being most preferred. A preferred thickness of bottom tapered portion 105 is between 2mm to 4mm (millimetres), 3mm being most preferred. The thickness of the bottom tapered portion 105 can be maintained throughout the base portion 10, for ease of manufacture. In addition, the base thickness provides mechanical and structural stability, while allowing flexibility of the liner 100 to be articulated to remove residual wax 60 easily. Preferred thicknesses, as indicated above, of top 104 1.5mm and bottom 105 3mm, are particularly suitable for a reusable candle liner 100 with an interior cavity 40 comprising an internal diameter of between 60mm to 100mm and an internal height of between 50mm to 100mm. Such a reusable candle liner 100 accommodates, e.g., approximately 220g of blended rapeseed and coconut wax 60, without compromising its structure or stability. Alternatively, a top tapered portion 104 thickness of 2mm and bottom tapered portion 105 thickness of 4mm supports an internal liner 100 (or candle) diameter of 100mm and height of 100mm. Such a reusable candle liner 100 accommodates, e.g., approximately 515g of blended rapeseed and coconut wax 60, without compromising its structure or stability. The type of wax 60 used can be, for example, soy, coconut, rapeseed, paraffin, beeswax, palm wax, gel wax, or any blended combination of these waxes. Examples of the wax 60 structure include molten, solid candle wax block, or beads. Weight of any wax (blend) can vary depending on an exact blend, or even on different raw materials or different suppliers. The weight of wax introduced into liner 100 may, thus, vary. The side wall 30 structure can, therefore, be configured according to a known wax type or weight to be placed into the liner, by consideration of, e.g., wall angle, tapering and/or height. Or a recommended maximum weight of wax can be a concept applied to a design of a specific example of liner 100. In effect, the liner 100, being free-standing, can act as a candle holder, accepting any type of conventional container candle without a requirement for an exact fit of the conventional candle into the liner 100. In other words, so long as the conventional candle is not too large for the liner 100, the candle can be smaller than the accommodating volume of the interior cavity 40 of the liner 100.

Refill line 102 is a safety feature of the reusable candle liner. Conventionally, it is advisable to discard a candle when a specific length or depth of wax is reached - as an example, between 1cm to 1.27cm (centimetres) remaining. According to United Kingdom safety guidelines, a candle should no longer be burned when the remaining candle wax depth is 1cm. Similarly, the United States of America guidelines require a depth of ½ (one half) inch or approximately 1.27cm. When such a wax level is reached, heat from any wick present in the candle, melts the associated smaller volume of total remaining wax to be fully molten, then continued burning results in the wax overheating and possibly exploding. Another risk comprises the heat from the fully molten wax starting to be absorbed by the candle holder. This increases a risk of candle holder failure, for example cracking of the holder or spillage of heated content.

It is, therefore, advantageous to provide a refill line 102 on the liner 100, according to the embodiments of the present invention, e.g. measured upwards from the base of the liner 100, to act as an indicator for the user to refill the liner 100 with replacement wax etc. Preferably, according to the embodiments of the present invention, the refill line 102 is positioned at least between 11mm and 12mm (upwards) from the base. But this should not be considered as limiting, said position referring to the safety requirements minimum for the United Kingdom. The refill line 102 preferably comprises a height of 1mm but this should also not be considered as limiting. This refill line 102 can be provided as a marked line, per se. For longevity, and preferably, the refill line 102 can be implemented by a protrusion (extra side wall 30 material thickness) or an indent (less side wall 30 material thickness), preferably convex or concave, respectively, for ease of forming in production, located on the inner side wall 30 of the liner 100. When the refill line 102 becomes visible to a user on the interior of the liner 100, it is because sufficient wax 60 has already been consumed. Alternatively, or additionally, a refill line can be placed on an outside surface of the side wall 30, to allow a user to gauge the wax 60 level by inspection. The visual indication, by means of a refill line 102, reminds the user to refill the liner with wax 60 and to stop burning the remaining wax 60. The liner 100, according to the embodiments of the present invention and as discussed above, is formed of material designed to minimise the transfer of heat to the outside of the liner (reduced heat transfer), either into air or towards any candle holder 300 into which the liner 100 is placed. Nevertheless, this refill line 102 feature allows for optimised implementation of candle safety protocol. The chosen, permanent, placement of the refill line 102 is related to an amount (or height) of wax 60 left in the liner 100. Once the wax 60 level drops below said refill line 102, insufficient wax 60 remains in the liner for safe burning.

Referring now to FIG. 3D and FIG. 3E, which show cross-sections of second and third examples, respectively, of the reusable candle liner 100 of the embodiments of the present invention, specific examples of liner 100 sizes and associated positioning of refill lines 102 will be discussed. (Please note these schematic drawings are not to scale).

FIG. 3D illustrates measurements of the second example of the reusable candle liner 100 of the embodiments of the present invention. This example comprises a tapered side wall 30 as illustrated for the first example. The liner 100 of the second example, designed in a preferred silicone material of shore hardness 60A, comprises the following measurements, a position of width line 106a also being indicative of a preferred maximum fill level for wax 60 :-

Width (across the diameter) at or proximate to the top 106a : 79.4mm

Width (across the diameter) at or proximate to the bottom 107a : 73mm

Internal liner height 108a : 73mm

Refill line height from the base 109a : 11mm

Refill line height from the top 110a : 61mm

Volumetric/weight capacity for wax (maximum recommended) : 220g (grams)

Outside (external) curve 50a radius of curvature : 9.92

Inside (internal) curve 50b radius of curvature : 8.8

FIG. 3E illustrates measurements of the third example of the reusable candle liner 100 of the embodiments of the present invention. This example also comprises a tapered side wall 30 as illustrated for the first example. The liner 100 of the third example, designed in a preferred silicone material of shore hardness 40A, comprises the following measurements, a position of width line 106b also being indicative of a preferred maximum fill level for wax 60 :-

Width (across the diameter) at or proximate to the top 106b : 80mm

Width (across the diameter) at or proximate to the bottom 107b : 73.5mm

Internal liner height 108b : 45mm

Refill line height from the base 109b : 11mm

Refill line height from the top 110b : 33mm

Volumetric/weight capacity for wax (maximum recommended) : 150g (grams)

Not shown in the figures, a fourth exemplary configuration of the liner 100, according to another preferred embodiment of the present invention, is provided. This fourth example comprises a silicone material with SH 40A, similar to the third embodiment. The liner 100 of the fourth example is provided with a straight side wall 30 (i.e. no tapering of the side wall, nor angular extension outwards, e.g. as shown in FIG. 1A) and a corner 50 is configured (e.g. as shown in FIG. 3B), the liner 100 comprising the following measurements: -

Width (across the diameter) at or proximate to the top 106a : 62mm

Width (across the diameter) at or proximate to the bottom 107a : 62mm

Internal liner height 108a : 50mm

Refill line height from the base 109a : 11mm

Refill line height from the top 110a : 38.5mm

Volumetric/weight capacity for wax (maximum recommended) : 100g (grams)

Outside (external) curve 50a radius of curvature : 6

Inside (internal) curve 50b radius of curvature : 3.13

In this fourth exemplary configuration of the liner 100, the refill line 102 is implemented as a coloured line, 0.5mm in (height) thickness, marked on the interior surface 30a of side wall 30, in the interior cavity 40.

It should be noted: for a silicone material of a relatively smaller Shore Hardness, a side wall 30 of a liner 100 tends to be reduced in height. This prevents a relatively soft(er) material forming an inward curl towards any candle flame at the wick 70.

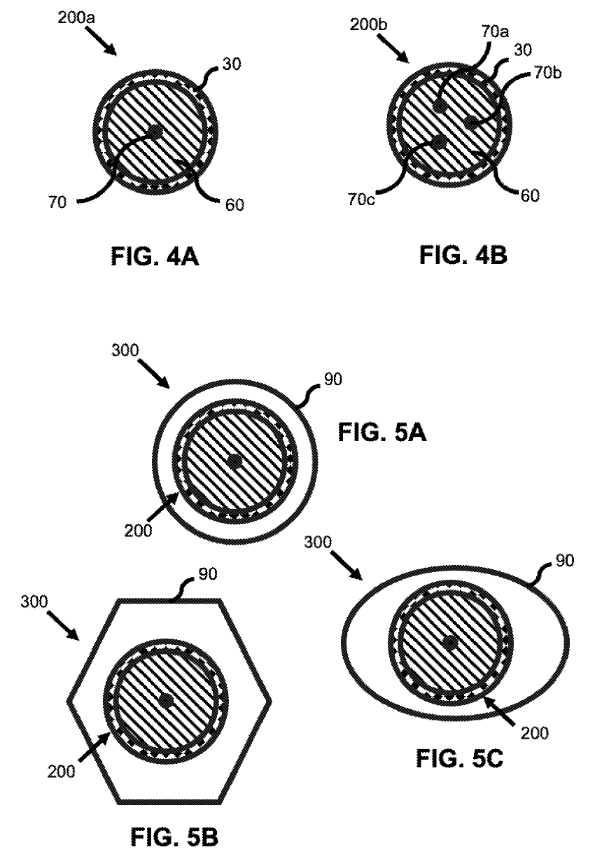

FIG. 4, parts A and B, shows schematic illustration of examples of a candle product 200 according to the embodiments of the present invention, as viewed from above (top view). Both figures exemplify a circular shape candle product 200 but this should not be considered as limiting. FIG. 4A shows a first candle product 200a comprising a reusable candle liner 100 according to an embodiment of the present invention, enclosing burnable wax 60 and a single wick 70. FIG. 4B shows a second candle product 200b comprising a reusable candle liner 100 according to an embodiment of the present invention, enclosing burnable wax 60 and three wicks 70a70b and 70c.

A candle product according to the embodiments of the present invention may comprise at least one wick 70 or a plurality of wicks 70a70b and 70c but is not limited to any specific number of the plurality of wicks. Conventional application of multiple wicks includes a principle that once a candle diameter is 7.5cm (centimetres), i.e. 75mm (millimetres), or more, then at least two wicks are advised. Similarly, three wicks are advised for a candle of 100mm diameter. However, this is not considered as limiting to the embodiments of the present invention - the type and characteristics of the wick being relevant, rendering a plurality of wicks applicable to many different sizes of candle. Any wick 70 facilitates the burning of wax 60 contained by the liner 100. While a wax 60 may have particular characteristics, unique to that wax 60, these characteristics being different for different waxes 60, the wick 70 is a main driver of the burn process. Selection of a wick 70 includes consideration of various parameters including, for example, composition of the wick core, the wax 60 being used, a percentage load of fragrance oil in the wax 60 and the diameter of the candle. Any wick(s) 7070a70b and 70c has specific characteristics, known in the art, for speed of burning in conjunction with the wax 60 (the wax 60 often comprising particular characteristics due to its constituent raw material(s)). This burn time can be controlled by the material of the wick 70 and, also, the placement of the wick 70 relative to the wax 60. An area of wax 60 local to a wick 70 is subject to melting, the degree of melt lessening according to the proximity. Provision of a plurality of wicks 70a70b and 70c in a single wax 60 material, as shown in FIG. 4B, allows a more even melt and burn over an extended area.

This has consequences for the liner 100 material, which may have to withstand a relatively higher temperature depending on the number of wicks 70 placed into the wax material 60.

Construction of the liner 100, as described herein, allows for even flow of heat, mechanically and materially structured to allow for escape of heat out of the interior cavity 40, without the top of the liner side wall 30 collapsing over the candle, or other trapping of the heat. The side wall 30 is not intended to transmit or radiate the heat under normal circumstances, the silicone material, which is not thermally conductive under normal circumstances, thereby protecting any holder 200. Consequently, the reusable candle liner 100, according to the embodiments of the present invention, is preferably made from silicone material which can safely withstand a range of temperatures, e.g. of up to 200⁰C, intermittently (intermittent being defined in the art as up to four hours burn time), with a usual operating temperature around 80⁰C, said operating temperature extending to 180⁰C.

FIG. 5, parts A to C, shows schematic illustration of examples of a candle holder 300 according to the embodiments of the present invention, as viewed from above (top view).

The candle holder 300 contains a candle product 200 comprising a reusable candle liner 100, according to the various embodiments of the present invention. As an example, the candle product 200 of FIG. 1D, with circular reusable candle liner 100, is illustrated in FIG. 5, parts A to C, but this should not be considered as limiting. However, the liner 100 can also be placed in the candle holder 300, by itself, i.e. empty of wax 60.

An advantage of the reusable candle liner 100, according to the various embodiments of the present invention, is the free-standing form. This allows said liner 100 to be placed into a candle holder without any requirement for the candle holder wall 90 to be in contact with the liner 100 for mechanical or structural support. In other words, according to the embodiments of the present invention, there is no requirement for the liner 100 to be attached to, or restrained by, the candle holder wall 90, or any other means. Thus, unlike many candle holders of the art, the candle holder 300 is not constrained in form or shape of the wall 90 because of the presence of either the liner 100 or a candle product 200, according to the embodiments of the present invention.

For example, FIG. 5A shows a candle holder 300 with a circular shape of wall 90, mirroring the shape of candle product 200. FIG. 5B shows a candle holder 300 with a hexagonal shape of wall 90. FIG. 5C shows a candle holder 300 with an oval shape of wall 90.

Due to the thermal properties of the material of the liner 100, comprising significantly reduced heat transfer in comparison to the provisions of the art, the candle holder wall 90 is not subject to excessive thermal heating effects from the candle product 200 when in (normal and usual) use, due to burning the wax 60. In addition, the separate liner 100 adds to the aesthetic of the candle holder 300.

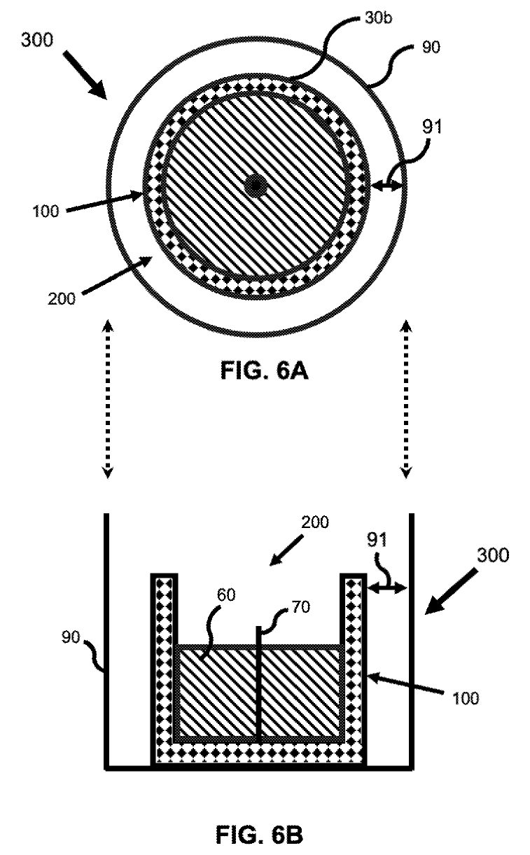

FIG. 6, parts A and B, shows further schematic illustration of the candle holder 300 of FIG. 5A. FIG. 6A shows a top view of said candle holder 300 and FIG. 6B the associated cross-section across a diameter, both FIG. 6A and FIG. 6B illustrating a gap 91 between the reusable candle liner 100 exterior wall 30b and the wall 90 of the candle holder 300 body.

The gap 91, indicated by the double ended arrow of the figure, is shown in FIG. 6A, in a preferred embodiment, being a consistent space around the candle product 200 with respect to the candle holder wall 90. This can be realised regardless of the shape of candle holder 300, due to the shape-ability and conformability of the liner 100 material, while maintaining its mechanical strength. With a consistent gap 91, the aforementioned reduced heat transfer and consequent thermal protection effect of the liner 100 is also consistent towards the candle holder wall 90. Due to the free-standing characteristic of the liner 100, provided there is sufficient space, it is not essential for the liner 100 shape to match that of the candle holder 300, nor for the gap 91 to be of uniform width around the liner 100.

In the latter case, this facilitates a liner 100 of a particular size to fit many different sizes of candle holders 300, thereby removing a requirement for dedicated inner part of a candle holder 300, and allowing easier re-use and less generation of waste products. Candle users frequently own many different candle holders 300 in their homes, for ambience and mental wellbeing. This aspect of the liner 100 of the embodiments of the present invention, provides easy refill process and easy removal of wax 60 for refill, while facilitating use of such a wide range of candle holders 300.

A preferred gap 91 size according to the embodiments of the present invention, advantageously, is not required to be different depending on the candle holder material. The gap 91 facilitates overall heat release but the liner 100 material has a protective effect. The presence of a gap provides further opportunity for heat to escape the holder 300 with liner 100 combination. Often, in the art, fire is started by candle holder failure due to excessive heat. Silicone, a preferred material for construction of the liner 100, of the embodiments of the present invention, is not thermally conductive (in normal use). Therefore, silicone tends not to aid in transferring heat from a candle (or wax) to the candle holder. The gap 91 creates additional spacing between the heat source and the candle holder wall 90. The liner 100 creates a natural barrier between heat source and candle holder 300, and increases the distance between heat source and candle holder 300. Thereby, decreasing heat transfer to candle holder, and in turn, increasing candle safety.

An aim to have no greater than a 2mm gap 91 between the candle holder 300 and liner 100 on the upper most diameter where the liner reaches the candle holder 300, is underpinned by the liner 100 being self-supporting. The mechanical and structural strength of the liner 100 facilitates creation of a relatively small gap 91. A ‘one size fits many candle holders 300’ approach can be implemented. Production of the liner 100 and the candle wax 60 block, which combines with the liner 100 to form the candle product 200, can be standardized, with the candle holder 300 being the variable. Specific candle block sizing can ensure a good and even burn for a pre-cast wax 60 candle block with a wick 70. The allowed variability of a plurality of candle holder 300 products (even of the same design and size) can then accommodate work by small artisan firms, to produce several candle holder designs. These artists often produce candle holders by hand, not by machined process, thereby inevitably introducing (relatively) more variability into any product.

The gap 91 is preferably between 0mm and 5mm (millimetres) in size, as measured in a direction approximately parallel to the holder 300 or liner 100 base 10. If the liner side wall is tapered (outward towards the top of the liner 100), the relevant gap size is measured at the top tapered portion 104 of side wall 30. Ideally, for aesthetic considerations, ease of removal from a candle holder 300 and safety, as well as tolerance towards a tapering of the side wall 30 of the liner 100, a preferred gap 91 size is around 2mm. In an exemplary embodiment, an external diameter of the liner 100 is around 70mm, then a preferred internal diameter of an associated candle holder 300 would be between 70mm to 80mm, comprising a most preferred internal diameter of around 74mm.

Advantageously, the gap 91 can be minimised towards zero gap, and into contact with the candle holder wall 90. (Also, for a liner 100 with a fully upright (vertical) side wall 30). While the liner 100 does not require support from said wall 90, the liner can provide thermal protection for said wall 90. Further advantageously, the flexibility of the liner 100 material allows easy removal of the liner from the candle holder 300. Also, the conformability of the reusable candle liner 100, allows easy fitting of said liner 100 into the candle holder 300.

The candle holder 300 assists in implementing candle safety. Given the burning nature of the product, candle safety should be emphasised. The use of a liner 100 placed in a candle safe candle holder 300 is preferably implemented using a candle holder 300 with minimum internal dimensions such that:
(1) the candle holder’s 300 internal diameter is equal to or greater than the liner’s 100 topmost external diameter, and
(2) the candle holder’s 300 internal height is equal to or greater than the liner’s 100 external height.

Although embodiments of the invention are described in the foregoing, it will be appreciated that the present invention is also susceptible to being implemented in a variety of combinations of the different embodiments proposed and in various ways.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

### LIST OF REFERENCE NUMERALS

100 reusable candle liner
200200a200b candle product
300 candle holder
10 base portion
20 top
30 side wall
30a interior of side wall
30b exterior of side wall
40 interior cavity
50 corner
50a outside curve
50b inside curve
60 wax
7070a70b70c wick
80 A to D side wall shape groups
81 oval
82 circle
83 decagon
84 pentagon
85 extended hexagon
86 triangle
87 rectangle
88 square with curved corners
89 square with cut-out corners
90 candle holder wall
91 gap between candle holder wall and exterior wall of liner
101 top rim
102 refill line
103 base rim
104 top tapered portion of side wall
105 bottom tapered portion of side wall
106a106b width of liner at or close to the top
107a107b width of liner at or close to the bottom
108a108b overall liner height
109a109b refill line height from base
110a110b refill line height from top

1. A reusable candle liner comprising an integrally moulded shaped form comprising a base portion, on which the reusable candle liner is configured to stand, and a side wall enclosing a interior cavity, suitable for placement of a candle, wherein said shaped form of the reusable candle liner further comprises a flexible material, configured to release the candle, or wax residue, by slippage, under elastic or mechanical deformation of the flexible material, before substantially resuming an original shape of the shaped form when said deformation is released.

2. The reusable candle liner according to claim 1, wherein the flexible material comprises a flexibility characteristic of Rebound percentage (%), which is configured to be within a range of 30% to 50%, inclusive.

3. The reusable candle liner according to claim 1, wherein the side wall is configured as extending from the base portion, continuously, in an upward direction away from the base portion, the flexible material being configured with sufficient hardness to be self-supporting and maintain linear structure of the side wall.

4. The reusable candle liner according to claim 1, wherein the side wall comprises a wall thickness which is greater proximate to the base portion at a bottom tapered portion of side wall and is tapered to be thinner at a top tapered portion of the side wall remote from the base portion and proximate to a top of the candle liner.

5. The reusable candle liner according to claim 1, wherein an edge of the base portion extending into the side wall is configured as a curved corner.

6. The reusable candle liner according to claim 1, wherein the flexible material of the shaped form comprises a silicone material.

7. The reusable candle liner according to claim 6, wherein said silicone material comprises a Shore Hardness, SH, in a range between 30A and 70A, inclusive.

8. The reusable candle liner according to claim 7, wherein the Shore Hardness, SH, of the silicone material is 60A or 40A.

9. The reusable candle liner according to claim 8, wherein a height of the side wall is related to the Shore Hardness, SH, of the silicone material chosen, such that the SH is harder for a liner with a higher or taller side wall than a liner with a lower or shorter side wall.

10. The reusable candle liner according to claim 6, wherein the silicone material is configured to comprise a heat tolerance in a range between 0⁰C and 200⁰C, inclusive, and to accommodate a wax surface temperature in a range between 0⁰C and 160⁰C, inclusive.

11. The reusable candle liner according to claim 1, wherein the side wall is shaped, around a circumference of the reusable candle liner, to comprise a free-form or a geometric shape, said geometric shape comprising at least one of the following shapes : an oval, a circle, a decagon, a pentagon, an extended hexagon, a triangle, a rectangle, a square with curved corners, a square with cut-out corners.

12. The reusable candle liner according to claim 1, wherein the side wall is shaped as symmetric around a central axis of the reusable candle liner.

13. The reusable candle liner according to claim 1, wherein, a refill line is provided on the side wall, adjacent to the interior cavity, comprising a ring around a circumference of the side wall, substantially parallel to the base portion, at a height above the base portion corresponding to a minimum depth of candle material or wax in the reusable candle liner.

14. The reusable candle liner according to claim 13, wherein the refill line is configured as an indent or a protrusion or a marking, on an interior surface or an exterior surface of the side wall.

15. The reusable candle liner according to claim 13, wherein the height of the refill line above the base portion is configured as between 10mm and 13mm.

16. The reusable candle liner according to claim 1, wherein, the reusable candle liner is configured as comprising :-
a width, across a diameter, at or proximate to a top thereof: 79.4 mm;
a width, across the diameter, at or proximate to a bottom: 73 mm;
an internal liner height: 73 mm;
a refill line height from the base: 11 mm;
a refill line height from the top: 61 mm;
an outside corner curve radius of curvature: 9.92;
an inside corner curve radius of curvature: 8.8;
and a maximum recommended volumetric or weight capacity for wax: 220 g;
and, wherein, the flexible material is configured to comprise a Shore Hardness of 60A and a Rebound percentage (%) of 48%.

17. The reusable candle liner according to claim 1,
wherein, the reusable candle liner is configured as comprising:-
a width, across a diameter, at or proximate to a top thereof: 80mm;
a width, across the diameter, at or proximate to a bottom thereof: 73.5mm;
an internal liner height: 45mm;
a refill line height from the base: 11mm;
a refill line height from the top: 33mm;
and a maximum recommended volumetric or weight capacity for wax: 150g;
and, wherein, the flexible material is configured to comprise a Shore Hardness of 40A and a Rebound percentage (%) of 50%.

18. A candle product comprising a reusable candle liner as claimed in claim 1, further comprising wax and at least one wick.

19. A candle holder comprising the reusable candle liner as claimed in claim 1.

20. A candle holder as claimed in claim 19, further comprising a consistent gap between an inner surface of the wall of the candle holder and an outer surface of the side wall of the reusable candle liner.
